(19) United States
(12) Patent Application Publication
(10) Pub. No.: US 2009/0006903 A1
(43) Pub. Date: Jan. 1, 2009

(54) Network Alarm Management

(76) Inventors: Ann Devitt, Dublin (IE); Robert Moloney, Cork (IE); Joseph Duffin, Co. Kildare (IE)

Correspondence Address: ERICSSON INC., 6300 LEGACY DRIVE, M/S EVR 1-C-11, PLANO, TX, 75024, US

(21) Appl. No.: 12/158,930

(22) PCT Filed: Dec. 23, 2005
(86) PCT No.: PCT/SE05/02014

§ 371 Date: Jun. 23, 2008

(51) Int. Cl. G06F 11/07

(52) U.S. Cl. 714/48; 714/E11.025; 714/E11.024

(57) ABSTRACT

In a fault management system, a method and a converting unit for converting correlated sequences of network alarms into a high level language format are disclosed. The method comprises receiving episodic alarm sequence for the correlated sequences obtaining a high level language scheme, and converting the episodic alarm sequence using the accessed high level language scheme into a high level language format, to enable more efficient and reliable fault management using the converted episodic alarm sequence in high level language format.

### TECHNICAL FIELD OF THE INVENTION

The present invention relates to network alarm management. In particular the invention relates to a method, a fault management unit, a fault management system and a computer program product, for managing condition rules of correlated alarms in networks.

### DESCRIPTION OF RELATED ART

Network systems produce on a daily basis a number of alarms, reflecting the state of network comprised objects and on the whole contain information about the network system behaviour.

Due to the inherent property of networks, a faulty condition at one place of a network is likely to automatically affect a neighbouring place of the network. Since this neighbouring place of the network in turn may affect a third place, faulty conditions of a network may quickly spread throughout the network.

When applying alarms to indicate faulty conditions, a faulty condition triggering an alarm easily gives rise to a number of new alarms of the network.

A network can produce thousands of individual alarms in a single day. Some of these alarms will have been triggered by a unique underlying fault. In other cases, a single fault condition will have triggered multiple correlated alarms. A network having a plurality of triggered alarms, indicating faulty conditions, is often parsed in a first attempt to identify the root cause of the faulty conditions. Typically inter dependencies between triggered alarms, are searched for.

Correlated alarms are consequently targeted in some prior art documents.

Fault management taking correlated alarm events into account is described by Tuchs, K. D. and Jobmann, K, in “Intelligent search for correlated alarms events in databases”, International Symposium on Integrated Network Management Proceedings, 2001 IEEE/IFIP, 2001, May 14-18, pp. 285-288. Information needed for correlation of alarms is claimed to be known only by system experts. In order to lower the number of errors that result from human operators a data mining tool, “Intelligent search of interesting patterns in sequences”, was developed to find correlated alarms. Alarm patterns on the basis of a topology model are presented to an operator for examination, leaving to the operator the task to relate the alarm pattern to a single triggering event.

Although the disclosure of Tuchs and Jobmann, reveals a search algorithm for correlated alarms, the task of relating the correlated faults to a potential triggering fault is still left to the operator.

In the patent document U.S. Pat. No. 6,353,902 B1 a network fault prediction and proactive maintenance system is disclosed. A database containing characteristics of a number of different network events or logs are created. The alarms as contained in the logs report the network status and abnormalities in the network. Upon occurrence of an event or log a fault occurrence is predicted based on an analysis of the log and the characteristics in the database. Prediction occurs dynamically once a log is detected, after which corrective steps are taken. An administrator is alerted about that step taken might not be sufficient to correct the predicted fault.

This network prediction and fault management system thus predicts the probability of the next fault in relation to an occurred fault and provides maintenance action to prevent probable and existing faults.

In “Experimental results on a constrained based sequential pattern mining for telecommunication alarm data”, Proceedings of the Web Information Systems 3-6 Dec. 2001, Jain-Zhi Ouh, et al. report on a mining algorithm that uses time constraints to restrict the time between alarms. A method for discovering sequential alarm patterns also comprises a step of cleaning undetermined alarm events.

This pattern mining for telecommunication alarm data is thus limited to the steps such cleaning of alarm events and discovering sequential alarm patterns, and does thus not provide correlated alarms adopted for further processing.

The inventors of the present invention reports on utilising the topology in network mining in “Topology proximity for mining network alarm data” in SIGCOMM'05 Workshops Aug. 22-26, 2005, Philadelphia, in the process of finding correlated alarm sequences. A topology proximity value is determined to reject or promote candidate sequences on the basis of their plausibility in terms of their strength of their connection in the network. Candidate sequence sets are reduced, where space and time constraints are optimised.

This paper presents mining of network alarm data by using proximity constraints but does not further provide a context within which a user can easily utilize this mining technique for facilitated network alarm management.

There is thus still a need to provide fault management of correlated alarms in telecommunications systems wherein the required human intervention is restricted.

### SUMMARY OF THE INVENTION

The invention is directed towards solving the problem of decreasing intensive human intervention required and heavy dependence on human expertise in avoiding mistakes when processing network alarm data.

This is generally solved by translating alarm condition rules into a user friendly and general high level language format.

One object of the present invention is thus directed towards providing a method for translating alarm condition rules into a user friendly and general high level language format.

This object is according to a first aspect of the present invention achieved through a method within a fault management system, of converting correlated sequences of network alarms into a high level language format, comprising the steps receiving episodic alarm sequence for the correlated sequences, obtaining a high level language scheme, converting the episodic alarm sequence using the accessed high level language scheme into a high level language format, to enable more efficient and reliable fault management using the converted episodic alarm sequence in high level language format.

A second aspect of the present invention is directed towards a method including the features of the first aspect, wherein the step of converting the episodic alarm sequences comprises sorting the episodic alarm sequences in relation to the accessed high level language scheme.

A third aspect of the present invention is directed towards a method including the features of the first aspect, wherein the step of converting the episodic alarm sequence comprises mapping high level language elements onto the episodic alarm sequence.

A fourth aspect of the present invention is directed towards a method including the features of the first aspect, wherein the step of converting further comprises assembling mapped high level language elements.

A fifth aspect of the present invention is directed towards a method including the features of the first aspect, wherein the step of obtaining a high level language scheme, comprises accessing the XML or SDL scheme.

A sixth aspect of the present invention is directed towards a method including the features of the first aspect, wherein the high level language elements comprises graphically displayable building blocks associated with the effect of the high level language element.

A second object of the present invention is to provide a unit for translating alarm condition rules into a user friendly and general high level language format.

This object is according to a seventh aspect of the present invention achieved through a fault management unit to be provided in fault management system for converting correlated sequences of network alarms into a high level language, said fault management unit comprising an episodic alarm sequence receiving unit, arranged to receive episodic alarm sequences for the correlated sequences, a high level language scheme providing unit, arranged to provide a high level language scheme, a converting unit connected to the episodic alarm sequence receiving unit and to the high level language scheme providing unit, where the converting unit is arranged to convert the episodic alarm sequence using the accessed high level language scheme into a high level language format, and a control unit, connected to the episodic alarm sequence receiving unit, to the high level language scheme providing unit and to the converting unit, where the control unit is arranged to control converting of the episodic alarm sequence using the accessed high level language scheme into a high level language format, to achieve a high level language formatted episodic alarm sequence.

An eighth aspect of the present invention is directed towards a fault management unit including the features of the seventh aspect, wherein the high level language providing unit is arranged to provide the SDL language.

A ninth aspect of the present invention is directed towards a fault management unit including the features of the seventh aspect, wherein the converting unit further comprises a mapping unit arranged to map high language elements onto the episodic alarm sequences.

A tenth aspect of the present invention is directed towards a fault management unit including the features of the seventh aspect, wherein the converting unit further comprises an assembling unit arranged to assemble mapped high level language elements forming high level language formatted episodic alarm sequences.

A third object of the present invention is to provide a fault management system for translating alarm condition rules into a user friendly and general high level language format.

This object is according to an eleventh aspect of the present invention achieved through a fault management system including the features of the seventh aspect, for management of network alarms.

A fourth object system of the present invention is to provide a computer program product for translating alarm condition rules into a user friendly and general high level language format.

This object is according to a twelfth aspect of the present invention achieved through a computer program product for converting correlated sequences of network alarms into a high level language, comprising computer program code to make a fault management unit perform when said code is loaded into said fault management unit, receiving of episodic alarm sequence for the correlated sequences, obtaining of a high level language scheme, and converting the episodic alarm sequence using the accessed high level language scheme into a high level language format, to enable more efficient and reliable fault management using the converted episodic alarm sequence in high level language format.

### BRIEF DESCRIPTION OF THE DRAWINGS

The present invention will now be described in more detail in relation to the enclosed drawings, in which:

FIG. 1 schematically shows the functionality of a fault management system, related to the present invention,

FIG. 2 presents a fault management converting unit, according to one embodiment of the present invention,

FIG. 3 shows a flow-chart of a method for converting network alarm condition rules, according to one embodiment of the present invention, and

FIG. 4 shows a computer program product in the form of a CD ROM disc comprising computer program code for carrying out the present invention.

### DETAILED DESCRIPTION OF THE EMBODIMENTS

The present invention will now be described in relation the fault management expert (FMX) fault management system. It should however be realised that the invention is not limited to the FMX Fault management system, but is applicable to any fault management system wherein network condition rules are to be converted into a high level language.

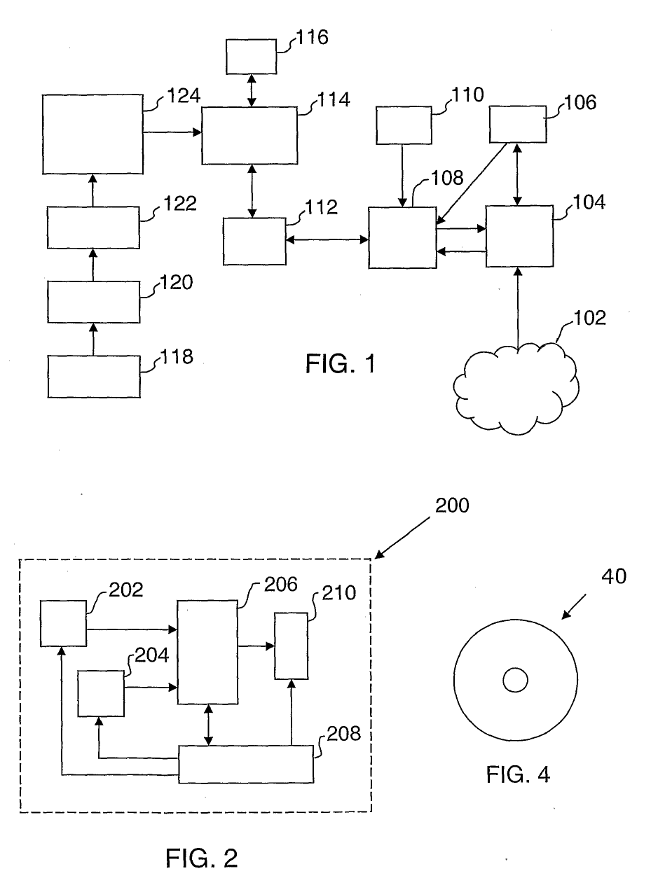

FIG. 1 schematically illustrates the functionality of a fault management system applied to manage the network 102. From the network 102 alarm elements are received by the fault manager 104, which is controlled by a user terminal 106. The fault manager 104 parses alarm data of network elements and parameterizes the alarm data to alarm records. The fault manager 104 has access to FMX rules that are logical sequences of operations to be executed in order to analyse and affect the current conditions/state of managed network. The fault manager 104 scans through the received alarm data and determines whether the alarm data is compatible with an FMX rule. If it is recognized that the alarm data fits an FMX rule, an FMX event has occurred and an FMX event corresponding alarm is sent to the FMX processor 108 to execute the FMX rule to the managed network 102. The FMX processor 108 thereafter returns the FMX processed alarm to the fault manager 104, such that the fault manager 104 can take advantage of that the FMX rule was already processed by the FMX processor 108. The FMX processor 108 is fed with network topology information from the network server 110, connected to the FMX processor 108.

The FMX rules are stored in FMX modules 112, from which the FMX processor 108 can gain access to the FMX rules for execution of the network rules analysing and managing the network conditions. The FMX rules are also created by an FMX development unit 114 under control of the FMX developer terminal 116. The FMX developer may create FMX modules containing FMX rules.

The FMX developer terminal 116 makes use of network statistics as assist in the manual search for FMX rules. FMX rules are generally rules for recognizing sequences of correlated network alarms.

The FMX system in general has good support for assembling large associated chains of alarm conditions to significant fault or failure events in the system. The chain assembling system is however dependent on the FMX developer having significant expertise in the telecommunication domain regarding fault events and their relationships to the working of components in the network.

One step to reduce the required level of expertise of the FMX developer is the application of a set of assisting functions that will be described hereinafter.

From an alarm database 118 real alarm conditions are provided to an alarm filtering, cleaning and transforming unit 120, which is responsible for the first step of alarm condition pre-processing. Pre-processed alarm conditions are thereafter forwarded to an alarm correlation unit 122, which unit is arranged to identify correlated sequences of network alarms within the alarm database 118. These steps are described by the authors in Devitt, A, et al., SIGCOMM'05 Workshops, Aug. 22-26, 2005, Philadelphia, Pa., USA, ACM 1-59593-026-4/05/0008, which here is incorporated by reference.

Identified sequences of correlated alarm conditions are forwarded to the FMX converting unit 124 that is arranged to convert the sequences of correlated alarm conditions into a high level language format, which high level language format is selected to be compatible with the FMX rules of the FMX development unit 114. It is also chosen such that it is can be easily read by the FMX developer terminal 116.

Since the present invention addresses the conversion of sequences of correlated alarm conditions, the FMX converting unit 124 will be described in more detail with reference to FIG. 2.

According to one embodiment of the present invention this FMX converting unit 200 comprises an episodic alarm sequence receiving unit 202, that is a unit that is arranged to receive sequences of correlated alarm conditions, a high level language scheme providing unit 204, and a mapping unit 206 arranged to map building blocks of a high level language onto the episodic alarm sequence. According to an alternative embodiment of the present invention, the mapping unit 206 is arranged to map episodic alarm sequence onto the building blocks of the high level language.

The FMX converting unit 200 further comprises a control unit 208, that is arranged to control the episodic alarm sequence receiving unit 202, the high level language scheme providing unit 204 and the mapping unit 206 of the FMX converting unit, according to the present invention. The output unit 210 connected to the mapping unit 206, is arranged to be able to forward the converted episodic alarm sequence to the FMX development unit 114.

According to another embodiment of the present invention is the FMX converting unit 200 comprised by a different set of units, for instance the high level language scheme providing unit may be comprised in a memory unit, alternatively comprised in the control unit 208. Other embodiments of the FMX converting unit 200 may also be envisaged.

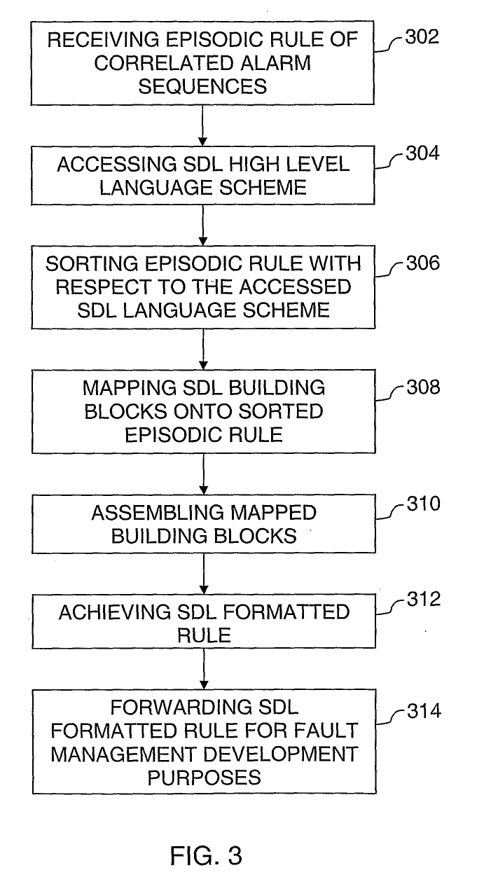

One method of converting episodic network alarm sequences of correlated alarms, is according to one embodiment of the present invention presented as a flow-chart in FIG. 3. The method starts by receiving an episodic alarm sequence, step 302. This step may be performed by episodic alarm sequence receiving unit 202 under control of the control unit 208. Next in line is the step of accessing an SDL high level language scheme, step 304, which step is performed by the mapping unit 206, accessing the high level language scheme providing unit 204 under control of the control unit 208, according to one embodiment of the present invention. Having accessed the SDL language in step 304, a step of sorting episodic alarm sequence with respect to the accessed SDL language scheme is performed in step 306. Typically this step of sorting, step 306, is performed by the mapping unit 206. The sorting step facilitates the subsequent step, step 308, of mapping SDL building blocks onto the sorted episodic rules, as being performed by the mapping unit 206. According to an alternative embodiment step 308 reads mapping sorted episodic alarm sequence onto SDL building blocks, as indicated above.

Having identified the building blocks that are being mapped out in step 308, these mapped out building blocks are assembled in step 310, such that they correspond to the episodic alarm sequence. This step of assembling is performed by the mapping unit 206, again under control of the control unit 208.

In this way an SDL formatted episodic alarm sequence is achieved in step 312, which step also is performed by the mapping unit 206 under control of the control unit 208, according to this embodiment of the present invention. Having achieved the SDL formatted alarm sequence this may be forwarded for fault management development purposes to the FMX development unit 114, as indicated in the additional step 314.

FIG. 4 shows a computer program code, in form of a CD-ROM, comprising computer code for carrying out the present invention.

It is emphasized that this invention can be varied in many ways, of which the alternative embodiments above only are examples of a few. These different embodiments are hence non-limiting examples. The scope of the present invention, however, is only limited by the subsequently following claims.

According to another embodiment the converting unit may comprise a different number of units, of which some units are comprised in others or that additional units are included, within deviating from the gist of the present invention.

According to yet another embodiment the method of converting episodic network alarm sequences may comprise a different number of steps, having additional steps or fewer steps, which can be realized by condensing two or more steps into a novel step.

According to yet another embodiment of the present invention, the high level descriptive language UML may be used as the high level language of the method. According to an alternative embodiment a language schema may be used instead of the language scheme, as exemplified in the text.

The high level language schema or scheme SDL is also known as ITU-SDL

There are various fields of application for the conversion method of the present invention. Analysis of alarm databases may comprise analysis of alternative data sources, such as diagnosis of illness from medical symptoms in patient databases or even errors in an assembly-line process, to mention a few examples only. The subsequent steps as comprised in the method of the present invention may therefore be designed to derive a hidden cause given a certain number of observable effects, such as medical effects or misfitting assembly elements, for instance, to present said chain or sequence of conditions in a high level format such that these conditions and their triggering event are compatible with and applicable to other comparable data sources.

The described present invention thus carries the following advantages:

The present invention decreases the level of expertise required to implement the network alarm correlation part.

It is further an advantage that correlated sequences of alarms are automatically constructed into a high level user friendly format.

These advantages are important in the light that of ever growing networks and full service requirements of demanding customers.

The present invention further facilitates the integration of existing data mining techniques into a more robust fault management process.

1. A method, within a fault management system, of converting correlated sequences of network alarms into a high level language format, comprising the steps:
receiving episodic alarm sequence for the correlated sequences,
obtaining a high level language scheme,
converting the episodic alarm sequence using the accessed high level language scheme into a high level language format,
to enable more efficient and reliable fault management using the converted episodic alarm sequence in high level language format.

2. The method of converting correlated sequences of network alarms according to claim 1, wherein the step of converting the episodic alarm sequences comprises sorting the episodic alarm sequences in relation to the accessed high level language scheme.

3. The method of converting correlated sequences of network alarms according to claim 1, wherein the step of converting the episodic alarm sequence comprises mapping high level language elements onto the episodic alarm sequence.

4. The method of converting correlated sequences of network alarms according to claim 1, wherein the step of converting further comprises assembling mapped high level language elements.

5. The method of converting correlated sequences of network alarms according to claim 1, wherein the step of obtaining a high level language scheme, comprises accessing an XML or SDL scheme.

6. The method of converting correlated sequences of network alarms according to claim 1, wherein the high level language elements comprise graphically displayable building blocks associated with the function of the high level language element.

7. A fault management unit to be provided in a fault management system, for converting correlated sequences of network alarms into a high level language, said fault management unit comprising:
an episodic alarm sequence receiving unit, arranged to receive episodic alarm sequences for the correlated sequences,
a high level language scheme providing unit, arranged to provide a high level language scheme,
a converting unit being arranged to convert the episodic alarm sequence using the accessed high level language scheme into a high level language format,
a control unit being arranged to control converting of the episodic alarm sequence using the accessed high level language scheme into a high level language format, to achieve a high level language formatted episodic alarm sequence.

8. The fault management unit according to claim 7, wherein the high level language providing unit is arranged to provide an SDL language.

9. The fault management unit according to claim 7, wherein the converting unit further comprises a mapping unit arranged to map high language elements onto the episodic alarm sequences.

10. The fault management unit according to claim 9, wherein the converting unit further comprises an assembling unit arranged to assemble mapped high level language elements forming high level language formatted episodic alarm sequences.

11. The fault management system comprising a fault management unit according to claim 7, for management of network alarms.

12. A computer program product for converting correlated sequences of network alarms into a high level language, comprising computer program code to make a fault management unit perform when said code is loaded into said fault management unit,
receiving of episodic alarm sequence for the correlated sequences,
obtaining of a high level language scheme,
converting the episodic alarm sequence using the accessed high level language scheme into a high level language format,
to enable more efficient and reliable fault management using the converted episodic alarm sequence in high level language format.
